(19) United States
(12) Patent Application Publication
(10) Pub. No.: US 2010/0131319 A1
(43) Pub. Date: May 27, 2010

(54) BUSINESS PROCESS SCHEDULE

(75) Inventor: Andrew Ioannou, San Francisco, CA (US)

Correspondence Address: TOWNSEND AND TOWNSEND AND CREW LLP/ORACLE, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/275,655

(22) Filed: Nov. 21, 2008

(51) Int. Cl. G06Q 10/00; G06N 5/02

(52) U.S. Cl. 705/8; 706/47

(57) ABSTRACT

Embodiments of the invention provide systems and methods for implementing a business process schedule based on temporal information. According to one embodiment, a method of utilizing temporal information associated with a business process definition can comprise storing the temporal information in a central repository. For example, the business process definition can comprise a Business Process Execution Language (BPEL) definition. The temporal information can indicate a time condition for a business process. A determination can be made as to whether the time condition has been satisfied. In response to determining the time condition has been satisfied, the business process definition associated with the temporal information can be identifying and executed.

### BACKGROUND OF THE INVENTION

The present invention relates generally to executing and/or managing business processes, and more specifically to implementing a business process schedule based on temporal information.

Software applications are increasingly being implemented to take advantage of business process definitions. Generally speaking, a business process is defined by a set of activities written in any of a variety of business process definition languages or scripts. These activities outline the steps to be performed in the process. For example, a business process can be defined to gather employee time through online timesheets, have the time approved by managers then transferred to the payroll application so that a payroll can be run. The steps in this business process might be written as: Time Entered By Employees; Online Time Entry System ‘Closed’ for entry; Timecards Approved; Timecards moved to Payroll; Payroll Run; and Direct Deposits Made. This business process might be implemented as a series of modules in a given piece of business software where the customer is responsible for carrying out the steps in the correct order or might even be implemented as a series of steps in software dealing with business process orchestration. In either case there may be additional and important time-related information that is not captured as data. For example, the previous time entry example may have the following time-related information (shown in parenthesis): Time Entered By Employees (by 5:00 pm Friday); Online Time Entry System ‘Closed’ for entry (at 5:10 Friday); Timecards Approved (by 11:00 am Monday); Timecards moved to Payroll (by 3:00 pm Monday); Payroll Run (by 10:00 am Tuesday); and Direct Deposits Made (by 5:00 pm Tuesday).

Many business processes involve time-related events which form part of the customers operations and policies but are not held anywhere in the software application. Currently, there is no consolidated repository of the temporal nature of customer's business processes. Rather, the timing of the steps in a business processes is managed manually by system administrators or certain significant dates might be held as data in various locations throughout the application. If the step in a business process is a batch process, an administrator or user might have scheduled the batch process to run at certain time(s) but that would have been in isolation of the context of the business process since there is no formal link between the job being scheduled and the step in the business process it represents. Hence, there is a need for improved methods and systems for implementing a business process schedule based on temporal information.

### BRIEF SUMMARY OF THE INVENTION

Embodiments of the invention provide systems and methods for implementing a business process schedule based on temporal information. According to one embodiment, a method of utilizing temporal information associated with a business process definition can comprise storing the temporal information in a central repository. For example, the business process definition can comprise a Business Process Execution Language (BPEL) definition. The temporal information can indicate a time condition for a business process. A determination can be made as to whether the time condition has been satisfied. In response to determining the time condition has been satisfied, the business process definition associated with the temporal information can be identified and executed.

Storing the temporal information in the central repository can comprise storing the temporal information in a repository containing the business process definition associated with the temporal information. In such a case, storing the temporal information in the repository containing the business process definition can comprise storing the temporal information as part of the business process definition. Alternatively, storing the temporal information in the central repository can comprise storing the temporal information in a repository separate from a repository containing the business process definition. In such a case, storing the temporal information in the central repository can comprise storing a temporal information record. The temporal information record can comprise an indication of the time condition and an indication of the business process definition. Identifying the business process definition associated with the temporal information can be based on the indication of the business process definition in the temporal record.

In some cases, prior to storing the temporal information in the central repository, a user interface can be presented and an indication of the temporal information and the business process definition can be received via the user interface. For example, the user interface can comprise a graphical representation of a calendar. In another example, the user interface can comprise a graphical representation of the business process definition.

According to another embodiment, a system can comprise a processor and a memory communicatively coupled with and readable by the processor. The memory can contain instructions which, when executed by the processor, cause the processor to store temporal information associated with a business process definition in a central repository. For example, the business process definition can comprise a Business Process Execution Language (BPEL) definition. The temporal information can indicate a time condition for a business process. A determination can be made as to whether the time condition has been satisfied. In response to determining the time condition has been satisfied, the business process definition associated with the temporal information can be identified and executed.

According to yet another embodiment, a machine-readable medium can have stored therein a series of instruction which, when executed by a processor, cause the processor to utilize temporal information associated with a business process definition by storing the temporal information in a central repository. For example, the business process definition can comprise a Business Process Execution Language (BPEL) definition. The temporal information can indicate a time condition for a business process. A determination can be made as to whether the time condition has been satisfied. In response to determining the time condition has been satisfied, the business process definition associated with the temporal information can be identifying and executed.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for implementing a business process schedule according to one embodiment of the present invention.

FIG. 4 is a flowchart illustrating a process for utilizing temporal information in a business process according to one embodiment of the present invention.

FIG. 5 illustrates an exemplary interface for defining a business process schedule according to one embodiment of the present invention.

FIG. 6 illustrates an exemplary interface for defining a business process schedule according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for utilizing a business process schedule. This schedule can contain the temporal, i.e., time-related, information about a set of business processes. The schedule could be implemented as or in a central repository where administrators can create and modify the timing of the various business processes taking place within their company. In addition to or instead of administrators, company executives could use the schedule to get an overview of how the company's business processes are ordered in time. An application concerned with or supporting a business process could then reference an event in the business process schedule to control the timing of steps in that business process. Further, certain events in the business process schedule could be used to initiate new business processes.

Stated another way, utilizing temporal information associated with a business process definition can comprise storing the temporal information in a central repository. For example, the business process definition can comprise a Business Process Execution Language (BPEL) definition. The temporal information can indicate a time condition for a business process. A determination can be made as to whether the time condition has been satisfied. In response to determining the time condition has been satisfied, the business process definition associated with the temporal information can be identifying and executed. Various additional details of embodiments of the present invention will be described below with reference to the figures.

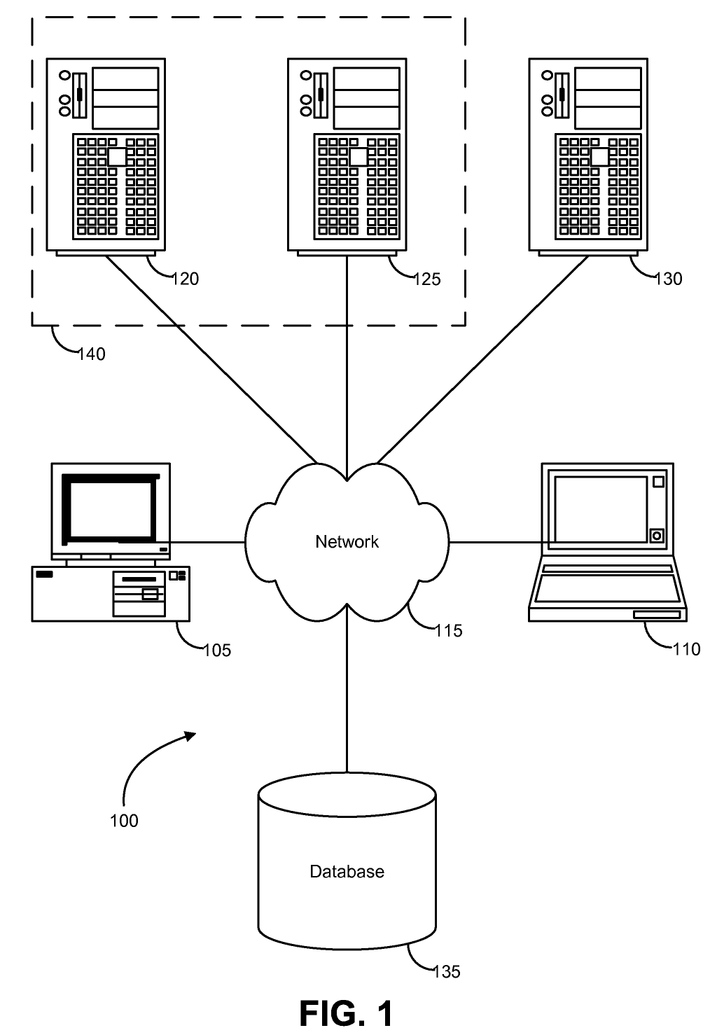

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®), Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10 g, that is adapted to store, update, and retrieve data in response to SQL-formatted commands.

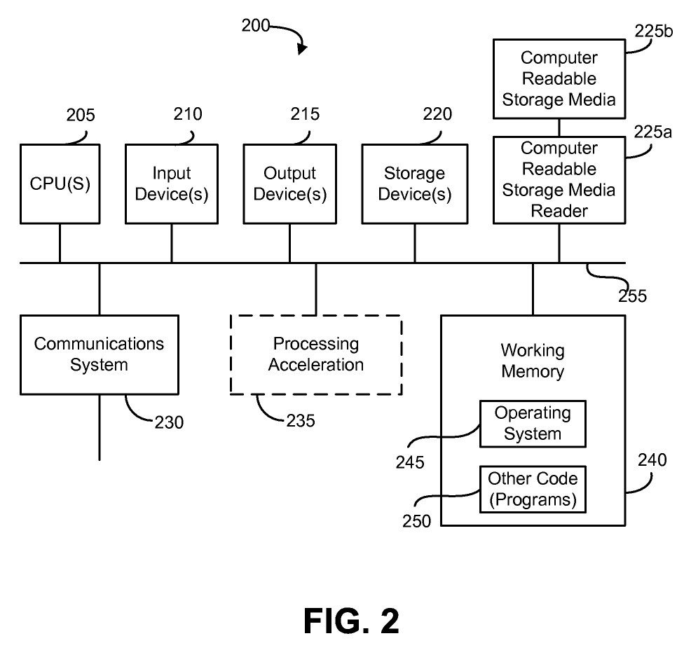

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

As noted above, embodiments of the present invention are directed to systems and methods for utilizing a business process schedule. This schedule can contain the temporal, i.e., time-related, information about a set of business processes. The schedule could be implemented as or in a central repository where administrators can create and modify the timing of the various business processes taking place within their company. In addition to or instead of administrators, company executives could use the schedule to get an overview of how the company's business processes are ordered in time. An application concerned with or supporting a business process could then reference an event in the business process schedule to control the timing of steps in that business process or to initiate new business processes.

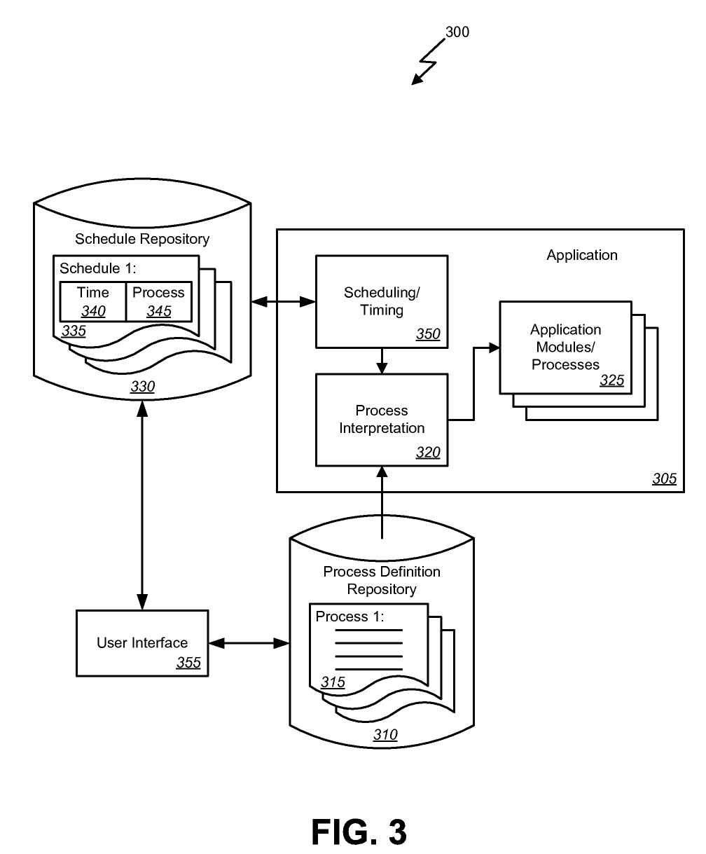

FIG. 3 is a block diagram illustrating, at a high-level, functional components of a system for implementing a business process schedule according to one embodiment of the present invention. In this example, the system 300 includes an application 325 executed by a computer system (not shown here) such as introduced above. The application 325 can comprise any of a variety of software applications such as, for example, an enterprise solution. The application can include a number of modules 325 for performing various processes as known in the art.

The system can also include a process definition repository 310 such as a database or other repository. The process definition repository 310 can include one or more sets of process definitions 315. Each process definition 315 can be directed to and can define one or more particular business processes. For example, each of the process definitions 315 can comprise a file defining a process through a set of statements such as Business Process Execution Language (BPEL) or other business process definition language statements. The application 305 can include a process interpretation module 320 that reads the process definition 315 from the process definition repository 310, interprets the BPEL or other language definition of the process, and initiates and/or influences the processing of the various application modules 325 to implement or execute the business process.

According to one embodiment, the system 300 can also include a schedule repository 330. The schedule repository 330 can comprise a database or other repository. It should be noted that, while illustrated here as separate from the process definition repository 310, in other implementations, the schedule repository 330 and the process definition repository 310 may in fact be the same physical and/or logical repository. The schedule repository 330 can include one or more sets of temporal information 335, i.e., schedules or calendars. According to one embodiment, the temporal information 335 can include one or more records that in turn include a time condition 340 and an indication of an associated process definition 345, e.g., one of the process definitions 315 in the process definition repository 310.

According to one embodiment, the time condition 340 can comprise an indication of a time, e.g., a date, day, time of day, etc. at which the process defined by the associated process definition 345 should be handled. For example, the time condition 340 can comprise an indication of a time at which the associated process should be initiated, a time by which it should be finished, etc. The time conditions can comprise both absolute time events (e.g., by the 3^{rd} of April) and relative ones (e.g., within 5 days of an event). The indication of the associated process definition 345 can comprise a name, reference, pointer, or other indication of a process definition 315 of the Process Definition Repository 310. According to one embodiment, the time condition 340 can comprise a time portion or statement, i.e., the date, day, time of day, etc., and a condition portion or statement, i.e., a statement of how the process is handled at or related to the specified time. Such a condition statement can comprise, for example, “start at,” “finish by,” “wait till,” etc. Alternatively, the condition statement portion of the time condition 340 can be defined in the associated business process definition 315.

The application 305 can also include a scheduling or timing module 350. The scheduling module 350 can be adapted to read and interpret the timing conditions 340 from the temporal information 335 and interact with the process interpretation module 320 and or application modules 325 to apply the timing condition 340 to the associated process definition 345 defined in the Process Definition 315 of the Process Definition Repository 310. For example and according to one embodiment, the scheduling module 350 can be adapted to publish events based on the temporal information 335 of the schedule repository 330 that could be acted upon by the process interpretation module 320 and/or application modules 325.

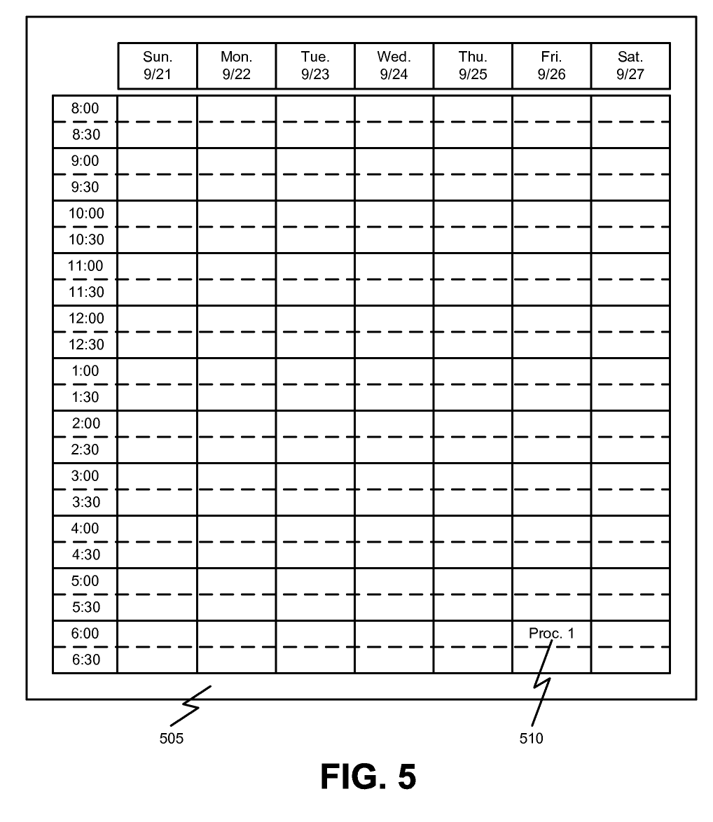

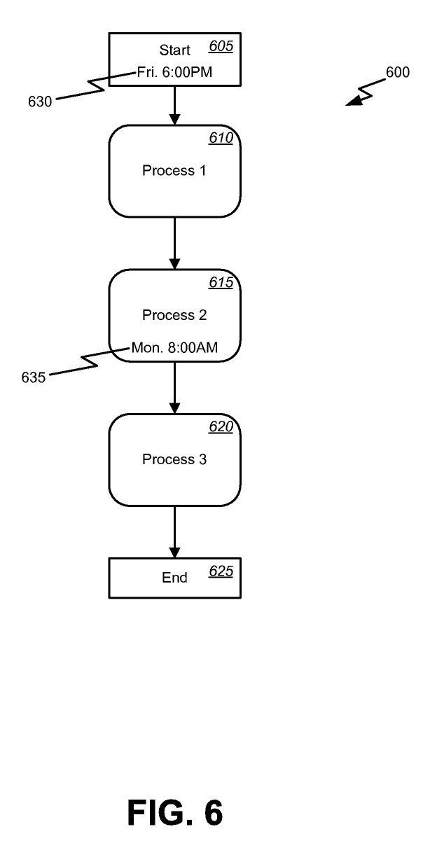

The application 305 and/or the scheduling module 350 can also provide a user interface 355. Generally speaking, the user interface 355 can comprise a graphical or non-graphical interface that allows an administrator or other user to see or create business processes and interact with and/or define the temporal information 335 of the schedule repository 330, for example through a database management system, web service, front end application, etc. (not shown here). Via the user interface 355 the temporal information 335 of the schedule repository 330 can be modified by a functional user who is only concerned with the business process at hand rather than the technical details of how software implements that process. For example, if a policy maker in the company wishes to extend the end of the window of time entry from Friday 5:00 pm to 7:00 pm they would only need access to the temporal information 335 defined in the schedule repository 330 rather than having to understand which part of which application 305 controls this policy. Exemplary user interfaces are described below with reference to FIGS. 5 and 6.

Stated another way, temporal information 335 associated with a business process definition 315 can be stored in a central repository. The temporal information 335 can indicate a time condition 340 for a business process. A determination can be made, for example by the scheduling module 350, as to whether the time condition 340 has been satisfied. In response to determining the time condition has been satisfied, the business process definition 315 associated with the temporal information 335 can be identified and executed by the process interpretation module 320 and/or application modules 325.

As noted above, storing the temporal information 335 in a central repository can comprise storing the temporal information 335 in a repository containing the business process definition 315 associated with the temporal information 335, i.e., the temporal information 335 can be stored in the Process Definition Repository 310. In such a case, storing the temporal information 330 in the repository containing the business process definition can comprise storing the temporal information 330 as part of the business process definition 315. Alternatively, storing the temporal information 335 in a central repository can comprise storing the temporal information 335 in a repository separate from a repository containing the business process definition 315, i.e., the temporal information 335 can be stored in the schedule repository 330 separate from the process definition repository 310. In such a case, storing the temporal information 335 in the central repository can comprise storing a temporal information record. The temporal information record can comprise an indication of the time condition 340 and an indication of the business process definition 345. Identifying the business process definition associated with the temporal information 335 can be based on the indication of the business process definition 345 in the temporal record.

In some cases, prior to storing the temporal information 335 in the central repository, a user interface 355 can be presented and an indication of the temporal information 335 and/or the business process definition 315 can be received via the user interface 355. For example, the user interface 355 can comprise a graphical representation of a calendar as described below with reference to FIG. 5. In another example, the user interface 355 can comprise a graphical representation of the business process definition as described below with reference to FIG. 6.

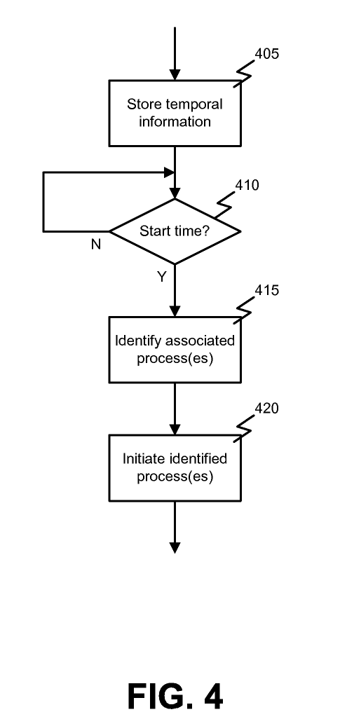

FIG. 4 is a flowchart illustrating a process for utilizing temporal information in a business process according to one embodiment of the present invention. In this example, the process begins with storing 405 the temporal information in a central repository. Storing 405 the temporal information in the central repository can comprise storing the temporal information in a repository containing the business process definition associated with the temporal information. In such a case, storing 405 the temporal information in the repository containing the business process definition can comprise storing the temporal information as part of the business process definition. Alternatively, storing 405 the temporal information in the central repository can comprise storing the temporal information in a repository separate from a repository containing the business process definition. In such a case, storing 405 the temporal information in the central repository can comprise storing a temporal information record.

The temporal information can indicate a time condition for a business process. A determination 410 can be made as to whether the time condition has been satisfied. In response to determining 410 the time condition has been satisfied, the business process definition associated with the temporal information can be identifying 415 and executed 420. The temporal information record can comprise an indication of the time condition and an indication of the business process definition. Thus, identifying 415 the business process definition associated with the temporal information can be based on the indication of the business process definition in the temporal record.

As noted above, prior to storing the temporal information in the central repository, a user interface can be presented and an indication of the temporal information and the business process definition can be received via the user interface. For example, the user interface can comprise a graphical representation of a calendar. In another example, the user interface can comprise a graphical representation of the business process definition. The following description of exemplary user interfaces is provided for illustrative purposes only and are not intended to limit the scope of the present invention. It should be understood that various other graphical and non-graphical user interfaces with various other formats, content, etc can be implemented. Furthermore, these variations are not considered to be mutually exclusive. Rather, various different interfaces can be used in combination to be displayed individually upon selection or request by the user and/or displayed together, side-by-side, overlaid, or with another arrangement. These variations are contemplated and considered to be within the scope of the present invention.

FIG. 5 illustrates an exemplary interface for defining a business process schedule according to one embodiment of the present invention. More specifically, this example illustrates the user interface can comprise a graphical representation of a calendar 505. Such a graphical representation can be presented, for example, as a web page viewable via a web browser of other application. It should be understood that, while a weekly view of the calendar 505 is illustrated here, daily, monthly, annual, and/or other views may be represented, perhaps based on a selection of a particular view by the user. Also, displayed on the calendar 505 can be one or more indications of a business process 510. This indication can be displayed with the calendar 505 based on previously defined temporal information. According to one embodiment, the user can manipulate a mouse, keyboard, pen, touch screen, or other input device to click on, touch, or otherwise select a time and/or a process. The user can then edit a time and/or indication of a business process to be correspondingly updated in the temporal information. For example, the user can select Monday at 3:00 and, once this calendar entry is selected, enter an indication of a process to be performed. In another example, the user can select an indication of a business process 510 already displayed and drag and drop or otherwise manipulate the interface to move that indication 510 to another time.

FIG. 6 illustrates an exemplary interface for defining a business process schedule according to one embodiment of the present invention. More specifically, this example illustrates the user interface can comprise a graphical representation of the business process definition 600. Such a graphical representation can be presented, for example, as a web page viewable via a web browser of other application. As known in the art, a graphical representation of a business process 600 can include a set of symbols representing various steps of sub-processes 605-625 within the business process. Indications of one or more times 630 and 635 can be displayed on the graphical representation of the business process definition 600. For example, an indication of a time 630 can be provided for starting 605 the business process. In another example, an indication of a time 635 may be indicated for a sub-process or step indicating a start time, deadline, or other condition for that sub-process.

The time indications 630 and 635 can be displayed with the graphical representation of the business process definition 600 based on previously defined temporal information. According to one embodiment, the user can manipulate a mouse, keyboard, pen, touch screen, or other input device to click on, touch, or otherwise select a time and/or a process. The user can then edit a time to be correspondingly updated in the temporal information. For example, the user can select the Process 2 indication 615 and, once this process indication is selected, enter or edit a time condition for this sub-process.

It should be understood that, while illustrated in this example as being displayed as part of the Process 2 indication 615, the corresponding temporal information 635 need not be embedded in or stored as part of the process definition. Rather, as described above with reference to FIG. 3, the temporal information can be stored in a schedule or set of temporal information separate from the business process definition. In this way, a user can access and change the temporal information that is used by the business process without accessing or affecting the business process definition. It should also be noted that, in some embodiments, a reference from the business process to the schedule or vise versa as described above could exist between any software application and the schedule. Therefore, at some point in code execution in such an application, a reference could be made to temporal information defined in the schedule. Additional or alternative variations are contemplated and considered to be within the scope of the present invention.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of utilizing temporal information associated with a business process definition, the method comprising:
storing the temporal information in a central repository, the temporal information indicating a time condition for a business process;
determining whether the time condition has been satisfied;
in response to determining the time condition has been satisfied, identifying the business process definition associated with the temporal information; and
executing the identified business process definition.

2. The method of claim 1, wherein storing the temporal information in the central repository comprises storing the temporal information in a repository containing the business process definition associated with the temporal information.

3. The method of claim 2, wherein storing the temporal information in the repository containing the business process definition comprises storing the temporal information as part of the business process definition.

4. The method of claim 1, wherein storing the temporal information in the central repository comprises storing the temporal information in a repository separate from a repository containing the business process definition.

5. The method of claim 4, wherein storing the temporal information in the central repository comprises storing a temporal information record, the temporal information record comprising an indication of the time condition and an indication of the business process definition.

6. The method of claim 5, wherein identifying the business process definition associated with the temporal information is based on the indication of the business process definition in the temporal record.

7. The method of claim 1, further comprising, prior to storing the temporal information in the central repository, presenting a user interface and receiving an indication of the temporal information and the business process definition via the user interface.

8. The method of claim 7, wherein the user interface comprises a graphical representation of a calendar.

9. The method of claim 7, wherein the user interface comprises a graphical representation of the business process definition.

10. The method of claim 1, wherein the business process definition comprises a Business Process Execution Language (BPEL) definition.

11. A system comprising:
a processor; and
a memory communicatively coupled with and readable by the processor, the memory containing instructions which, when executed by the processor, cause the processor to store temporal information associated with a business process definition in a central repository, the temporal information indicating a time condition for a business process, determine whether the time condition has been satisfied, and in response to determining the time condition has been satisfied identify the business process definition associated with the temporal information and execute the identified business process definition.

12. The system of claim 11, wherein storing the temporal information in the central repository comprises storing the temporal information in a repository containing the business process definition associated with the temporal information.

13. The system of claim 12, wherein storing the temporal information in the repository containing the business process definition comprises storing the temporal information as part of the business process definition.

14. The system of claim 11, wherein storing the temporal information in the central repository comprises storing the temporal information in a repository separate from a repository containing the business process definition.

15. The system of claim 14, wherein storing the temporal information in the central repository comprises storing a temporal information record, the temporal information record comprising an indication of the time condition and an indication of the business process definition.

16. The system of claim 15, wherein identifying the business process definition associated with the temporal information is based on the indication of the business process definition in the temporal record.

17. The system of claim 11, wherein the instructions further cause the processor to present a user interface and receive an indication of the temporal information and the business process definition via the user interface prior to storing the temporal information in the central repository.

18. The system of claim 17, wherein the user interface comprises a graphical representation of a calendar.

19. The system of claim 17, wherein the user interface comprises a graphical representation of the business process definition.

20. The system of claim 11, wherein the business process definition comprises a Business Process Execution Language (BPEL) definition.

21. A machine-readable medium having stored therein a series of instruction which, when executed by a processor, cause the processor to utilize temporal information associated with a business process definition by:
storing the temporal information in a central repository, the temporal information indicating a time condition for a business process;
determining whether the time condition has been satisfied;
in response to determining the time condition has been satisfied, identifying the business process definition associated with the temporal information; and
executing the identified business process definition.

22. The machine-readable medium of claim 21, wherein storing the temporal information in the central repository comprises storing the temporal information in a repository containing the business process definition associated with the temporal information.

23. The machine-readable medium of claim 22, wherein storing the temporal information in the repository containing the business process definition comprises storing the temporal information as part of the business process definition.

24. The machine-readable medium of claim 21, wherein storing the temporal information in the central repository comprises storing the temporal information in a repository separate from a repository containing the business process definition.

25. The machine-readable medium of claim 24, wherein storing the temporal information in the central repository comprises storing a temporal information record, the temporal information record comprising an indication of the time condition and an indication of the business process definition.

26. The machine-readable medium of claim 25, wherein identifying the business process definition associated with the temporal information is based on the indication of the business process definition in the temporal record.

27. The machine-readable medium of claim 21, further comprising, prior to storing the temporal information in the central repository, presenting a user interface and receiving an indication of the temporal information and the business process definition via the user interface.

28. The machine-readable medium of claim 27, wherein the user interface comprises a graphical representation of a calendar.

29. The machine-readable medium of claim 27, wherein the user interface comprises a graphical representation of the business process definition.

30. The machine-readable medium of claim 21, wherein the business process definition comprises a Business Process Execution Language (BPEL) definition.
